(19) United States
(12) Patent Application Publication
(10) Pub. No.: US 2014/0316856 A1
(43) Pub. Date: Oct. 23, 2014

(54) METHOD AND SYSTEM FOR CONDUCTING A DEDUCTIVE SURVEY

(71) Applicant: Mindshare Technologies, Inc., Salt Lake City, UT (US)

(72) Inventors: Kurtis Williams, Fruit Heights, UT (US); Jon Grover, Sandy, UT (US); John Crofts, Sandy, UT (US)

(21) Appl. No.: 14/203,384

(22) Filed: Mar. 10, 2014

Related U.S. Application Data
(60) Provisional application No. 61/775,370, filed on Mar. 8, 2013.

(51) Int. Cl. G06Q 30/02

(52) U.S. Cl. CPC G06Q 30/0204
USPC 705/7.32

(57) ABSTRACT

A method for conducting real-time dynamic consumer surveys is disclosed. The method includes providing a set of user-defined topics of interest related to a specific good or service and providing a processor configured for beginning a consumer survey by providing an open-ended question to the consumer of the specific good or service regarding the consumer's experience with said good or service, receiving the consumer's response to said open-ended question, analyzing the text of said response to the open-ended question to identify the presence of members of the set of user-defined topics within the response, and providing at least one closed-ended question with respect to any member of the set of user-defined topics not identified in the consumer's response.

### PRIORITY

This application claims priority to U.S. Provisional Patent Application No. 61/775,370 filed on Mar. 8, 2013 entitled “Method and System for Deductive Surveying Based on Text Input” which is incorporated herein by reference in its entirety. Additionally, this application is a continuation-in-part of currently pending U.S. Ser. No. 13/042,397 entitled “Method and System for Recommendation Engine Optimization” filed on Mar. 7, 2011 which is also incorporated by reference herein in its entirety.

### FIELD OF THE TECHNOLOGY

The present technology relates generally to computer systems for optimizing consumer surveys. More particularly, the present technology relates to an analysis tool that assesses customer responses to an open-ended survey question and tailors additional questions based on deductive processing tools.

### BACKGROUND

The present technology relates generally to computer systems for optimizing consumer analysis of text input, also known as customer comments, in consumer surveys to optimize survey length and quality. Modern computer administered customer feedback surveys are difficult to correctly design, long and unpleasant for respondents to complete, difficult to analyze, suffer from data anomalies such as multi-co-linearity and a “halo effect,” can only ask a limited set of questions, and are “top down” focused on researcher requirements rather than customer experiences. In some instances, text analysis of consumer textual comments has been used generally to extrapolate information related to those responses. Thus, a need exists for improved systems for consumer survey design, construction, operation, and use.

### BRIEF DESCRIPTION OF THE DRAWINGS

Additional features and advantages of the technology will be apparent from the detailed description which follows, taken in conjunction with the accompanying drawing, which illustrates, by way of example, features of the technology; and, wherein:

FIG. 1 is a block diagram of components of a method according to one aspect of the technology;

FIG. 2 is a diagram of a static survey design;

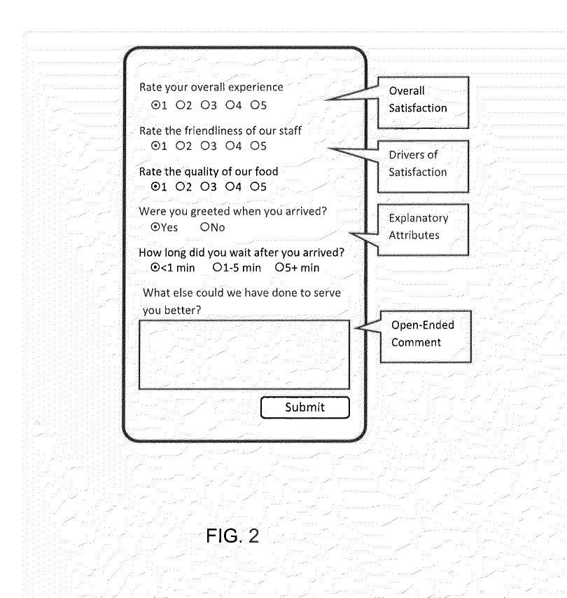

FIG. 3 is a diagram of a method according to one aspect of the technology; and

FIG. 4 is a diagram of a method according to one aspect of the technology.

### DESCRIPTION

Reference will now be made to, among other things, the exemplary aspects illustrated in the drawing, and specific language will be used herein to describe the same. It will nevertheless be understood that no limitation of the scope of the technology is thereby intended. Alterations and further modifications of the inventive features illustrated herein, and additional applications of the principles of the technology as illustrated herein, which would occur to one skilled in the relevant art and having possession of this disclosure, are to be considered within the scope of the technology.

Generally speaking, in accordance with one aspect of the technology, a system and method for conducting a deductive survey based on text input from a customer begins with asking the customer to answer at least one open-ended question about their overall experience with respect to a particular good or service. In real-time, the system analyzes the comment with voice and/or text analytics to determine what the customer said about their experience. Each topic mentioned by the customer is tagged and analyzed for sentiment. The next question or set of questions would then be determined based on the customer response to the first and each successive question and so on. This approach is completely inverted from the typical approach to customer feedback surveys.

One purpose of consumer surveys is to gather data on attitudes, impressions, opinions, satisfaction level, etc. by polling a section of consumers in order to gage consumer satisfaction. In accordance with one aspect of the technology, a survey takes the form of a questionnaire composed of questions that collect data. This data helps impose structure on the survey. The types of data collected can include (i) nominal data where the respondent selects one or more unordered options (e.g., “Which of the following did you like best about the product: Price, Taste, or Packaging?), (ii) ordinal data where the respondent chooses an ordered option (e.g., “Please rate the taste of the product from 1 to 5.”), (iii) dichotomous data where the respondent chooses one of two (possibly ordered) options (“Did you like the taste of the product?), and (iv) continuous data which is ordered on a (possibly bounded) continuous scale. These types of data are called structured data and are the result of a structured or closed-ended question. Unstructured textual data may be captured from structured responses including names, dates, addresses, and comments.

Data used to ascertain customer satisfaction can be obtained from multiple disparate data sources, including in-store consumer surveys, post-sale online surveys, voice surveys, comment cards, social media, imported CRM data, and broader open market consumer polling, for example. Several factors are included in determining a composite score or numerical representation of customer satisfaction. That numeral representation is referred to as a Customer Satisfaction Index (“CSI”) or Primary Performance Indicator (“PPI”). There are a number of other methods for deriving a composite numerical representation of customer satisfaction. For example, Net Promotor Score (NPS), Guest Loyalty Index (GSI), Overall Satisfaction (OSAT), Top Box, etc. are composite representations of the same. This list is not exhaustive and many other methods exist to use mathematical methods to derive a numeric representation of satisfaction or loyalty would be apparent for use herein by one of ordinary skill in the art. Efforts have been made to determine optimal actions to increase the CSI for a particular situation. Data retrieved from customer feedback sources ranking their satisfaction with a particular service or product is compiled and used to calculate an aggregate score. As such, the efficient procurement of correct consumer satisfaction data is critical.

The activities that will most likely have the greatest influence on the CSI, referred to as key drivers herein, are important to understand. Key driver analysis includes correlation, importance/performance mapping, and regression techniques. These techniques use historical data to mathematically demonstrate a link between the CSI (the dependent variable) and the key drivers (independent variables). Key drivers may both increase and decrease the CSI, or both, depending on the particular driver. For example, if a bathroom is not clean, customers may give significantly lower CSI ratings. However, the same customers may not provide significantly higher CSI ratings once the bathroom reaches a threshold level of cleanliness. That is, certain key drivers provide a diminishing rate of return. Other drivers may also be evaluated but that do not have a significant impact on CSI. For example, a restaurant may require the use of uniforms in order to convey a desired brand image. Although brand image may be very important to the business, it may not drive customer satisfaction and may be difficult to analyze statistically.

Once a CSI is determined and key drivers are identified, the importance of each key driver with respect to incremental improvements on the CSI is determined. That is, if drivers were rated from 1 to 5, moving an individual driver (e.g., quality) from a 2 to a 3 may be more important to the overall CSI than moving an individual driver (e.g., speed) from a 1 to a 2. When potential incremental improvement is estimated, key driver ratings for surveys are evaluated to determine the net change in the CSI based on incremental changes (either positive or negative) to key drivers. Specific actions necessary to incrementally modify the key drivers are determined after an optimum key driver scheme is determined. Those actions, referred to as specific or standard operating procedures (“SOPs”), describe a particular remedial step connected with improving each driver, optimizing profit while maintaining a current CSI, or incrementally adjusting CSI to achieve a desired profit margin. In short, the SOPs constitute a set of user specified recommendations that will ultimately be provided to improve the CSI score.

As noted above, one purpose of a survey is to study the behavior of a group of people and in particular to understand consumer preferences and consumer satisfaction with the goods and services of business and industry. As such, a model is useful to attempt to numerically describe the group of people in a predictable manner. In accordance with one aspect of the technology, a survey data model includes questions designed to understand a primary measured value (e.g., the PPI referenced above). The data acquired from a response to this question is also called the “dependent variable”, “regressand,” “measured variable,” “response”, “output variable,” or “outcome.” An example question seeking a primary measured value would include “Rate your overall experience on a scale of 1 to 5.” The model further includes one or more explanatory questions that explain the primary score. The data acquired from these types of questions are called “independent variables,” “key driver,” “regressor”, “controlled variable,” “explanatory variable”, or “input variable.” Similar to the question seeking information related to the primary measured value, a question seeking information related to the independent variable would include “Rate the service you received on a scale of 1 to 10.” Both of these questions are examples of closed-ended questions. While the response to each of these questions is specific and provides value information to the business concern, consumer surveys can be overly burdensome on consumers who do not wish to spend a lot of time to answer questions and who may not provide meaningful answers, if any, if the survey is too long. In order to acquire all of the information desired by the business concern, consumers may be requested to answer pages and pages of questions.

In addition, many survey designs suffer from a well-known cognitive bias balled the “Halo Effect.” If a person has a positive or negative bias towards a particular brand (created by previous experiences or marketing, for example) than all answers from that person tend to be positively or negatively influenced. Comment narratives from the same consumers may be less subject to ratings' bias caused by the Halo Effect. Other flaws in survey design also contribute to bias. For example, long surveys tend to influence customers to “speed through” the survey and inaccurately answer the questions just to complete the survey. Or, questions may be designed such that consumers do not understand the question posed or cannot differentiate between the meanings of different, similarly posed, questions. For example, satisfaction surveys often ask respondents to “rate the friendliness of our staff” and then “rate the attentiveness of our staff.” Both questions are seeking different information but may appear to be the same to many respondents. This is known as co-linearity and is a flaw that does not exist in textual analysis of consumer responses to open-ended questions.

As an example, a typical/traditional retail static consumer survey may ask the following questions:
1. Computer: “Please rate your overall satisfaction with the [service] on a scale from 1 to 5.” (The overall satisfaction may be an ordinal data point used as primary performance indicator as noted above.)
2. Computer: “Please rate the service on a scale from 1 to 5.” (The service rating may be an ordinal data point used as a key driver.)
3. Computer: “Please rate the product on a scale from 1 to 5.” (The product rating may be an ordinal data point used as a key driver.)
4. Computer: “Please rate the selection of products on a scale from 1 to 5.” The selection rating may be used as an ordinal data point in a key driver analysis as noted above.)
5. Computer: “Please rate the store appearance on a scale from 1 to 5.” (Again, this rating may be used as an ordinal data point in a key driver analysis.)
6. Computer: “What area of service could be improved?” (A response to this question would provide an explanatory attribute and provides nominal data for use in survey analysis.)
7. Computer: “How could the product be improved?” (A response to this question would also be an explanatory attribute and provides nominal data for use in survey analysis.)
8. Computer: “Were you greeted at the entrance of the store?” (A response to this question is also an explanatory attribute. However, the data procured is dichotomous or “a yes or no/true or false” response to be used in survey analysis.)
9. Computer: “Tell us about your experience.” (A response to this question would also provide an explanatory attribute but is unstructured text. The consumer is not provided any guidance as to what part of the service he or she liked or disliked.)

As noted above, surveys can become long as the set of explanatory features grows. Often some combinations of questions are nonsensical. For example, it is pointless to ask a question about a fast food restaurant's tables if the customer purchased via a drive-through window. However, because a particular business concern does not differentiate between those consumers when requesting a survey, it is required to pose the question nevertheless to capture information from a consumer that may have eaten at the restaurant. Moreover, a broad generic consumer survey may not even address the topics that are of primary concern to the consumer or drive the overall consumer satisfaction. For example, a business concern may ask about overall satisfaction and ask closed-ended questions the business concern believes affects overall satisfaction, but the consumer's concerns regarding the experience and overall satisfaction may not be included within the set of closed-ended questions. For example, a consumer may be dissatisfied with his or her overall experience at a drive-through window because it was raining and the drive-through was not covered. Unless the business concern includes this question in its survey, understanding the value of follow up questions to ascertain key drivers to improve overall customer satisfaction is diminished. That is, the consumer may rate food quality as high and service as high, but overall satisfaction low leaving the business concern with no valuable data on how to improve customer satisfaction. A business concern with numerous facilities (some with covered drive-through windows and some without) is therefore forced to include yet another question on a long list of possible consumer concerns.

In accordance with one aspect of the technology, it is desirable to ask follow-up questions that further explain a particular answer or, as noted further below, ask initial open-ended questions that drive the organization of the remainder of the survey. For example, if a customer initially rates product quality as low, it is useful to ask the customer what they did not like about quality. In accordance with one aspect of the technology, the model includes one or more descriptive questions that further explain a previous question and that can be used as secondary predictors of the primary value. These questions are also called “drill-in,” “attributes,” or “features.” For example, if the consumer gave a low score to service, a closed-ended follow-up question might be “Select what was bad about the service you received: (“slow | rude | incorrect”). The data model is used for data analysis including trending, comparative studies and statistical/predictive modeling. This data is structured and can be modeled inside a computer database. Even though surveys can be very detailed with many questions, they often cannot capture every case. Here, the consumer score regarding service may not be poor because of the three items provided in the closed-ended question. Advantageously, an unstructured text or “open-ended question” may be used for the respondent to use to fill in the gaps or for a user to gage what is most important to the consumer's experience with his or her goods. For example, an open-ended question following a low score on service might be “Tell us in your own words why you rated us poorly on our service.” In this manner, the business concern is not limited by the specific set of potential problems the consumer may have encountered. As a result, survey length may be shortened and the value of information harvested from consumer responses is improved.

In one aspect of the technology, a customer might be asked the following open-ended question at the beginning of a consumer survey: “Please tell us about your experience.” If a customer left the following feedback “I had a good experience at your restaurant and was very pleased with how friendly and attentive Sam was with our party. Our food did take a little bit longer than usual to come out, but our party was pretty large. Thanks for a fun and enjoyable time,” the following facts would be extracted from text analysis of the consumer response.

1. The customer was overall satisfied with the experience
2. The friendliness and attentiveness of the staff was great
3. The speed of service was good

These facts are used to deductively generate additional questions that are contextually relevant to the consumer experience. This allows a direct survey where the respondents are required to endure less questions. The effectiveness of the questions and value of the data retrieved the questions is more reliable as they relate specifically to the feedback generated by the consumer.

In accordance with one aspect of the technology, automated linguistics-based analyses of data are used to assess grammatical structures and meaning within the consumer responses. These solutions are based on natural language processing (NLP) or computational linguistics and are useful in identifying topics of interest contained in consumer responses to open-ended questions. For example, linguistics-based classification techniques are used to group noun terms. The classification creates categories by identifying terms that are likely to have the same meaning (also called synonyms) or are either more specific than the category represented by a term (also called hyponyms) or more general (hyperonyms). For additional accuracy, the linguistic techniques excludes adjective terms and other qualifiers. In another aspect of the technology, categories are created by grouping multiple-word terms whose components have related word endings (also called suffixes). This technique is very useful for identifying synonymous multiple-word terms, since the terms in each category generated are synonyms or closely related in meaning. In another aspect, categories are created by taking terms and finding other terms that include them. This approach based on term inclusion often corresponds to a taxonomic hierarchy (a semantic “is a” relationship). For example, the term sports car would be included in the term car. One-word or multiple-word terms that are included in other multiple-word terms are examined first and then grouped into appropriate categories. In another aspect of the technology, categories are created based on an extensive index of word relationships. First, extracted terms that are synonyms, hyponyms, or hyperonyms are identified and grouped. A semantic network with algorithms is used to filter out nonsensical results. This technique produces positive results when the terms are known to the semantic network and are not too ambiguous. It is less helpful when text contains a large amount of specialized, domain-specific terminology that the network does not recognize.

In accordance with one aspect, a statistical analysis of text is based on the frequency with which terms, types, or patterns occur. This technique can be used both on noun terms and or other qualifiers. Frequency refers to the number of records containing a term or type and all its declared synonyms. Grouping items based on how frequently they occur may indicate a common or significant response. This approach produces positive results when the text data contains straightforward lists or simple terms. It can also be useful to apply this technique to any terms that are still uncategorized after other techniques have been applied.

In accordance with one aspect of the technology, the taxonomies, ontologies, dictionaries, and business rules used to extract information from unstructured text may be further customized and enhanced for a specific industry or organization. Domain knowledge experts who are well versed in a particular industry or organization is encoded into the text analytics systems. In this manner, the system provides more contextually relevant questions to the survey respondent rather than “off the shelf” text analytics that lack contextual reasoning and logic. For example, restaurant terminology is different from retail clothing terminology as is insurance and contact center terminologies. Business rules for each specific industry is integrated with an industry specific survey.

The facts extracted from customer comments through NLP technology are used to restructure a survey in real time. That is, the facts are used to dynamically create follow-up questions while the survey is being conducted. One example of an open-ended question and follow-up questions is presented below. In this example, a hotel manager desires to understand how customers rate their experience and what was most important to them. Rather than provide a long list of questions that may or may not be of concern to the consumer, an open-ended question is posed to provide the consumer with the opportunity to identify those areas that were most important to the consumer. Follow-up questions are generated in response to the facts and topics of interest generated by the consumer as well as topics of interest generated by the user of the model. In this example, information that the hotel manager identifies as important to the business includes: overall experience rating, service rating, room rating, fair price, and concierge service rating. All other data is optional but still useful to the hotel manager. The system first poses an open-ended question as noted below with an example response from the consumer.

Computer: “Tell us in your own words about your experience.”

Consumer: “I really didn't have a good experience with your hotel. The bell service was slow and a bit rude, plus I didn't get room service at all. At the prices you charge, I expect more.”

Based on the consumer response, the following facts might be extracted from the comment using NLP or computational linguistics: The consumer had a poor experience; the bell service was slow; the employees were rude; room service was poor; price was mentioned; and expectations were not met. Based on the facts extracted from the comment, the system generates a set of closed-ended follow-up questions in order to obtain ratings with respect to the specific items referenced. Additionally, specific questions from the system user (i.e., the hotel manager) wishes asked as part of the survey are included to rate user-generated topics in addition to the consumer-generated topics of interest. The following is one example set of follow-up questions:
1. Computer: “I'm sorry you had a poor experience. We'd like to do better. Can you rate your experience on a scale of 1 to 5?”

### Consumer: 5

2. Computer: “You mentioned price, was the price you were charged fair?”

### Consumer: No

3. Computer: “You didn't mention the concierge service. Did you use it?”

### Consumer: Yes

4. Computer: “Please rate the concierge service on a scale of 1 to 5.”

### Consumer: 4

5. Computer: “Can you tell us what you liked about the concierge?”
   Consumer: “They helped us find tickets to a sold out show. That was very helpful.”
6. Computer: “One last question, can you rate the quality of your room?”

### Consumer: 4

In the example noted above, question number one is a closed-ended follow-up question that is based on a consumer-generated topic of interest and provides the user of the system, again the hotel manager in this example, valuable feedback that has a direct correlation to the consumer's comment. Question number 2 also asks a closed-ended follow-up question correlated to a consumer-generated topic of interest with a specific rating. Questions 3 through 6, are follow-up questions that are user-generated. That is, the user of the system may have specific business goals and/or other operational concerns for which it desires direct consumer feedback. As such, in addition to closed-ended questions correlated to consumer-generated topics of interest, open and closed-ended questions are asked based on user-generated topics of interest. In one aspect of the technology, those follow-up questions are only generated if the topics are not already identified in the consumer-generated topics of interest. However, in one aspect of the technology, the user-identified topics may not be asked at all depending on the length of the consumer response, the number of consumer-identified topics that are generated from the textual analysis, and the relative value of the information to the user. This allows the survey to be dramatically shorter. For example, if parking lot cleanliness were less important than the friendliness of the staff and the open-ended structure herein had already elicited greater than a user-defined threshold number of follow-up questions, specific questions related to parking lot cleanliness may not be asked. In this manner, the user sets a “respondent tolerance level” for answering and responding to questions which is balanced with the relative value of information sought through the survey.

In accordance with one aspect of the technology, an analysis (e.g., employing statistics, specific business rules, or otherwise) of the topics identified in consumer responses is performed to assess the confidence in the results of identified topics. Closed-ended follow-up questions are asked regarding topics that were identified by the user as important but which did not appear in the comment or for which the confidence interval is low. Specific rating questions directed towards those topics identified, narrow and refine the rating process to those areas specifically addressed by the consumer and which matter to the consumer. A set of business rules provided by the user is used to ask additional questions based on the specific ratings and/or additional goods/services for which the user desires specific information.

In one aspect of the technology, statistical analyses are performed regarding the confidence interval of topics identified from the consumer comment. Confidence intervals consist of a range of values (interval) that act as estimates of the unknown population parameter. In this case, the topics identified in a consumer comment constitute the unknown population parameter, though other population parameters may be used. In infrequent cases, none of these values may cover the value of the parameter. The level of confidence of the confidence interval would indicate the probability that the confidence range captures this true population parameter given a distribution of samples. It does not describe any single sample. This value is represented by a percentage. After a sample is taken, the population parameter is either in the interval made or not; it is not a matter of chance. The desired level of confidence is set by the user. If a corresponding hypothesis test is performed, the confidence level is the complement of respective level of significance. That is, a 95 percent confidence interval reflects a significance level of 0.05. The confidence interval contains the parameter values that, when tested, should not be rejected with the same sample. Greater levels of variance yield larger confidence intervals, and hence less precise estimates of the parameter.

In accordance with one aspect of the technology, if the calculated statistical confidence interval does not meet or exceed a user-defined threshold value (e.g., greater than 90 percent) on any of the topics identified, the system prompts the customer to confirm their perceived sentiment with a rating question. For example, if the textual analysis of the consumer comment resulted in a possible negative consumer sentiment with respect to a service, but the confidence interval was below that set by the user, a specific rating question would be generated and posed.

Computer: “You mentioned the cleanliness of the parking lot in your response. Can you rate the cleanliness of the parking lot on a scale of 1 to 5?”

If the confidence interval regarding consumer sentiment of the cleanliness of the parking lot was within an acceptable range, follow up questions ranking the parking lot, for example, would not need to be asked. A rating could be assigned based on the textual analytics of the response. For example, if the consumer said “the parking lot was filthy” a value of 1 may be assigned to the consumer rating without the need of a specific follow-up question. As noted above, if the specific topic was not mentioned by the customer (e.g., the cleanliness of the parking lot), and the user desired to collect information about the parking lot, the survey would generate follow-up questions: “You didn't mention the parking lot. Did you use the parking lot?” After an affirmative answer, a closed-ended question such as “Rate the cleanliness of the parking lot from 1 to 5” may be asked or another open-ended question may be asked such as “What did you think of the parking lot?” In one aspect of the technology, the choice between open or closed-ended questions is a function of user-defined rules setting a value on the topic of interest and the current length of the survey.

In one aspect of the technology, business rules supplied by the user (i.e., the business concern) are applied to dynamically alter the flow of the survey. For example, a rule can be applied that states: “If the respondent answers 4 or higher on the Service Rating, ask them the Favorite Service Attribute question.” A similar rule can be asked for negative responses: “If the respondent answers 3 or lower on the Service Rating, ask them the Least Favorite Service Attribute question.” Similarly, if an open-ended question results in a consumer response that is determined to be negative (e.g., a response using the words “hate” or “gross,” or variations thereof, is detected), a business rule asking specific follow-up questions is implemented.

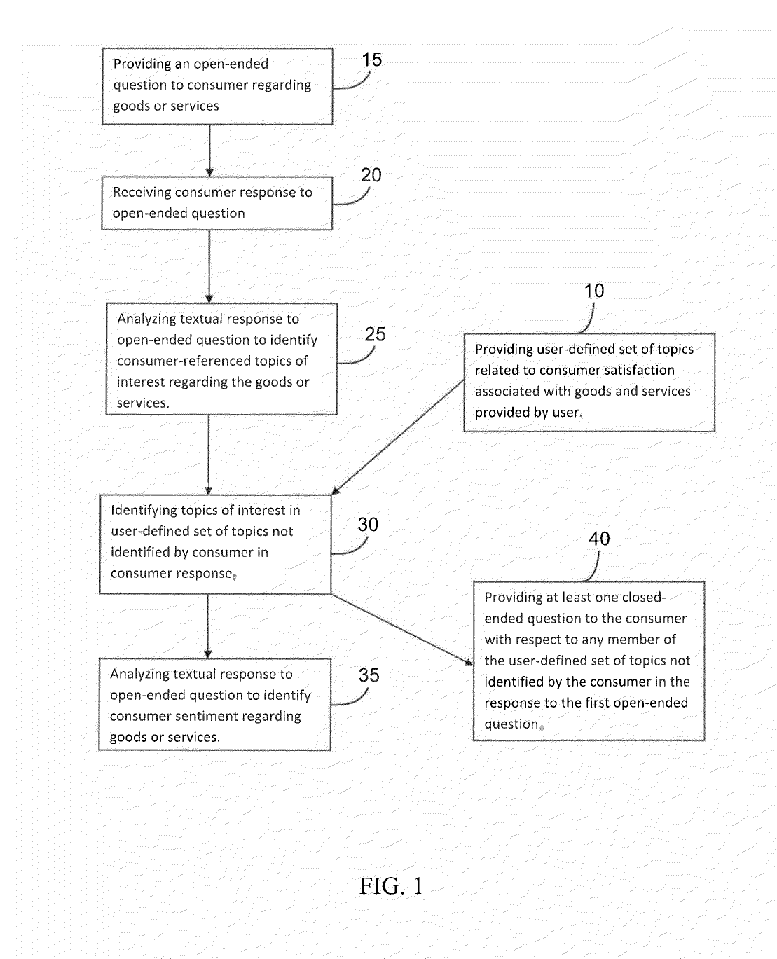

With reference to FIG. 1, in one aspect of the technology, a method for conducting real-time dynamic consumer experience surveys, the method under control of one or more computer systems configured with executable instructions, comprises providing a set of user-defined topics of interest related to a specific good or service provided by the user to a consumer 10. The method further comprises providing a processor configured for providing an open-ended question to the consumer 10 of the specific good or service regarding the consumers 10 experience with said good or service 15, receiving the consumers 10 response to said open-ended question 20, analyzing the text of said response to the open-ended question 20 to identify consumer-identified topics of interest 25, identifying the presence of members of the set of user-defined topics not within the response 30, analyzing the text of said response to the open-ended question 20 to identify sentiment measure regarding said goods or services 35, and providing at least one closed-ended question 40 with respect to any member of the set of user-defined topics not identified in step number 30, wherein said closed-ended question 40 is a function of a predetermined set of rules 40.

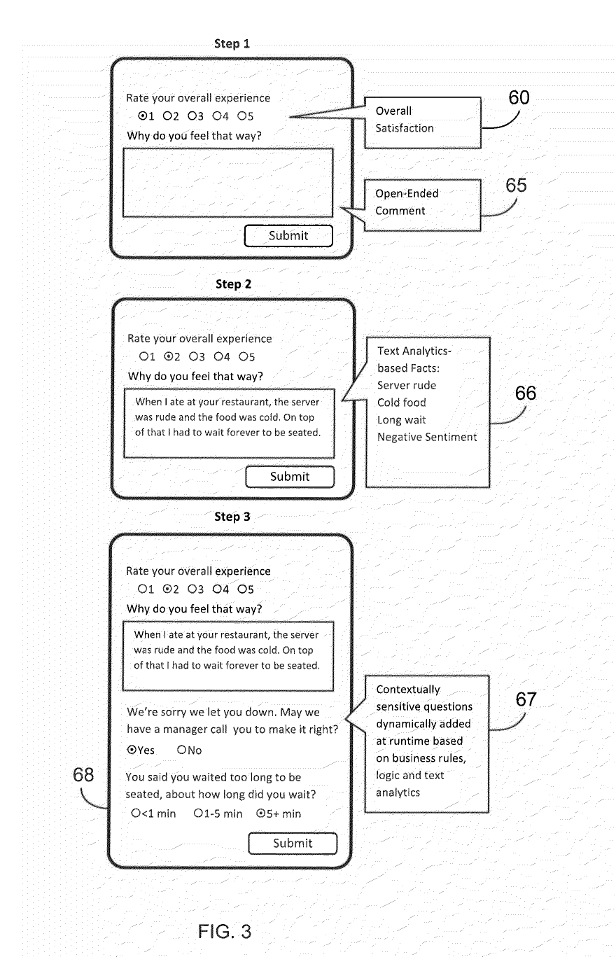

With reference to FIG. 3, in one aspect of the technology, a method for conducting real-time dynamic consumer experience surveys comprises beginning the survey by asking the consumer to provide an overall rating of the experience 60 and prompting the consumer with an open-ended question to explain why he or she provided the specific rating 65. The text of the consumer response (whether entered originally in text format or generated from a voice response), is analyzed using natural processing language, for example, to ascertain consumer-identified topics that correlate to the experience score 66. Contextually sensitive questions are dynamically generated based on user-defined business rules 67. In one aspect of the technology, those rules are industry specific and are suited to specific business needs. A closed-ended question 68 related to specific topic identified by the consumer in his or response is proffered. In one aspect, the closed-ended question is derived from a set of user-defined rules that relate to the topic identified by the consumer. For example, if the consumer indicates they waited too long for a table, a closed-ended question 68 is posed that provides the consumer with an opportunity to provide a structured response.

In another aspect of the technology, deductive survey logic is employed to improve the quality of the comments themselves, in addition to direct open-ended questions to the respondent, the system prompts the user to discuss additional points in their comment as they are typing. This can shorten a survey experience and improve the length and quality of the comment itself. Advantageously, this results in an improved survey experience for the respondent while simultaneously yielding better analytic data for analysis. In many situations, the respondent does not have much incentive to elaborate deeply. For example, if a respondent had a great overall experience, it is not uncommon for them to simply reply in their comment something similar to “everything was great.” In aggregate, this scenario is so common that phrases like “everything was great” introduce noise into text analysis which presents a large problem to text analytics teams.

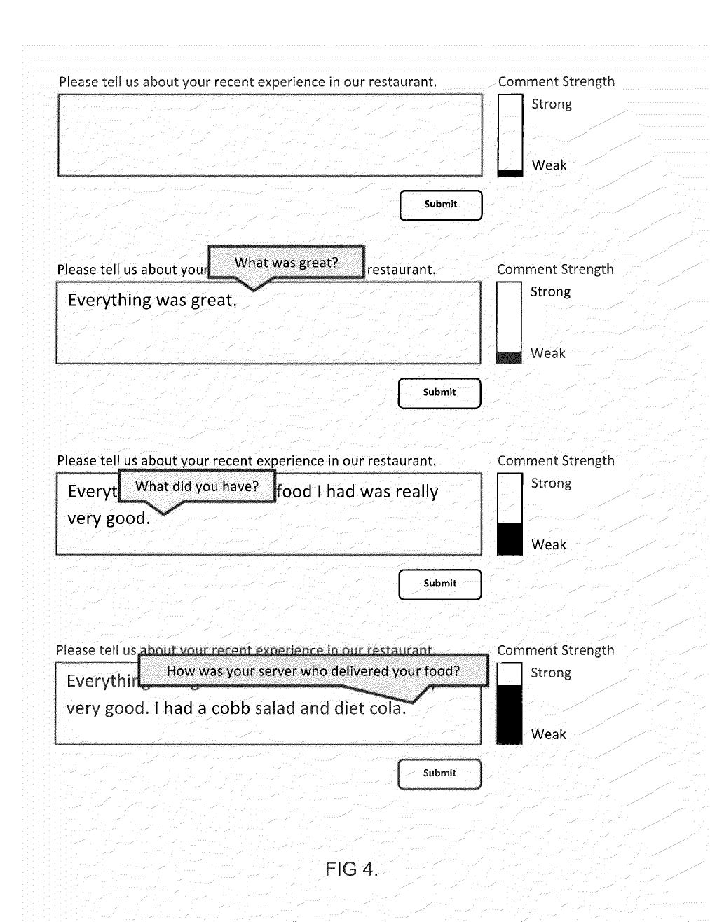

In one aspect of the technology, with reference generally to FIG. 4, if a respondent is asked, “Rate your experience on a scale of 1 to 5,” and the respondent provides a rating of 5, they are asked in an open-ended question to, “Explain in your own words why you feel that way,” They then reply that, “Everything was great.” The system uses custom dictionaries and taxonomies to identify numerous ways of expressing that sentiment. Identifying that the respondent has replied with an overly simplistic phrase, the system prompts the respondent to enrich their comment. For example,

Computer: “Rate your experience on a scale of 1 to 5”

### Respondent: 5

Computer: “Please tell us in your own words why you feel that way.”
Respondent: “Everything was great.”
Computer (prompting): “What was great?”
Respondent (adds): “The food was very good.”
Computer (prompting): “What did you have?”
Respondent (adds): “I had a cobb salad and a diet cola.”
Computer (prompting): “Tell us about the server who delivered your food.”
Respondent (adds): “The server was pretty nice and made a good menu suggestion.”

In the original comment, no actionable information is given by the respondent. By further prompting using deductive text analytics logic, additional facts including Food Quality, Salad, Cola, Friendly Service, and Menu Item are acquired. The comment prompts are generated by evaluating the consumer text as he or she enters the answer and provides a contextually appropriate prompt to extract useful information. In one aspect of the technology, the quality of the prompts is improved by the use of industry/domain specific text analytics including user-defined business rules, taxonomies, dictionaries, ontologies, hierarchies, and the like. Moreover, the prompts can be driven by text analytics facts acquired from prior elements of the survey, including, but not limited to sentiment analysis, and previously collected structured data (ratings, context data, etc.).

Numerous styles of visual prompts are contemplated herein. In one aspect, a prompt box or bubble appears in close proximity to the consumer's text as they type a comment. The prompt box includes the prompt that assists the consumer in providing additional information. In yet another aspect, a “comment strength” indicator visually cues the consumer as to how useful the comment is. As many consumer surveys are linked to incentives for completing a survey, in one aspect, incentives may be increased for stronger consumer comments. In one aspect of the technology, the “submit” button enabling the consumer to complete the survey is not activated, until the “comment strength” indicator reaches an acceptable level.

The methods and systems described herein may be used in connection with a network comprising a server, a storage component, and computer terminals as are known in the art. The server contains processing components and software and/or hardware components for implementing the consumer survey. The server contains a processor for performing the related tasks of the consumer survey and also contains internal memory for performing the necessary processing tasks. In addition, the server may be connected to an external storage component via the network. The processor is configured to execute one or more software applications to control the operation of the various modules of the server. The processor is also configured to access the internal memory of the server or the external storage to read and/or store data. The processor may be any conventional general purpose single or multi-chip processor as is known in the art.

The storage component contains memory for storing information used for performing the consumer survey processes provided by the methods and apparatus described herein. Memory refers to electronic circuitry that allows information, typically computer data, to be stored and retrieved. Memory can refer to external devices or systems, for example, disk drives or other digital media. Memory can also refer to fast semiconductor storage, for example, Random Access Memory (RAM) or various forms of Read Only Memory (ROM) that are directly connected to the processor. Computer terminals represent any type of device that can access a computer network. Devices such as PDA's (personal digital assistants), cell phones, personal computers, lap top computers, tablet computers, mobile devices, or the like could be used. The computer terminals will typically have a display device and one or more input devices. The network may include any type of electronically connected group of computers including, for instance, Internet, Intranet, Local Area Networks (LAN), or Wide Area Networks (WAN). In addition, the connectivity to the network may be, for example, remote modem or Ethernet.

The foregoing detailed description describes the technology with reference to specific exemplary aspects. However, it will be appreciated that various modifications and changes can be made without departing from the scope of the present technology as set forth in the appended claims. The detailed description and accompanying drawing are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the invention should be determined solely by the appended claims and their legal equivalents, rather than by the descriptions and examples given above.

1. A method for conducting real-time dynamic consumer surveys, the method under control of one or more computer systems configured with executable instructions, comprising:
providing a set of user-defined topics of interest related to a specific good or service provided by the user to a consumer;
providing a processor configured for:
(a) beginning a consumer survey by providing an open-ended question to the consumer of the specific good or service regarding the consumers experience with said good or service;
(b) receiving the consumer's response to said open-ended question;
(c) analyzing the text of said response to the open-ended question to identify the presence of members of the set of user-defined topics within the response;
(d) providing at least one closed-ended question with respect to any member of the set of user-defined topics not identified in step number (c), wherein said closed-ended question is a function of a predetermined set of rules.

2. The method of claim 1, wherein the processor is further configured for analyzing the text of said response to the open-ended question to identify a sentiment measure regarding said goods or services

3. The method of claim 1, further comprising generating at least one closed-ended question with respect to members of the user-defined topics identified in the consumer's response to the open-ended question.

4. The method of claim 3, wherein the closed-ended question includes a request to rate consumer satisfaction with respect to the goods or services.

5. The method of claim 2, further comprising assigning an ordinal data value to consumer sentiment based on the textual analysis of the consumer's response to said open-ended question.

6. The method of claim 5, wherein the ordinal data value assigned to the consumer sentiment is based off of a set of user-defined rules.

7. The method of claim 2, further comprising assessing a confidence interval of the identified consumer sentiment regarding the goods or services.

8. The method of claim 7, further comprising assessing the confidence interval associated with identification of consumer sentiment and generating at least one closed-ended question to specifically identify consumer sentiment if the confidence interval is below a user-defined threshold.

9. The method of claim 8, wherein the closed-ended question comprises a request to rate consumer sentiment with respect to the goods or services.

10. The method of claim 1, further comprising assessing the confidence interval associated with the identified members of the set of user-defined topics and generating at least one closed-ended question to specifically identify at least one member of the set of user-defined topics if the confidence interval is below a user-defined threshold.

11. The method of claim 10, wherein the closed-ended question comprises a request to rate at least one member of the set of user-defined topics.

12. The method of claim 11, further comprising asking a closed-ended question requesting a narrative regarding a positive attribute of the at least one member of the set of user-defined topics if the rating of the at least one member of the set of user-defined topics is greater than a user-defined threshold value.

13. The method of claim 11, further comprising asking a closed-ended question requesting a narrative regarding a negative attribute of the at least one member of the set of user-defined topics if the rating of the at least one member of the set of user-defined topics is less than a user-defined threshold value.

14. A system for conducting real-time dynamic consumer surveys, the system comprising:
one or more computer systems configured with executable instructions, comprising a set of user-defined topics of interest related to a specific good or service provided by the user to a consumer; and
a processor configured for:
(a) providing an open-ended question to the consumer of the specific good or service regarding the consumers experience with said good or service;
(b) receiving the consumers response to said open-ended question;
(c) analyzing the text of said response to the open-ended question to identify the presence of members of the set of user-defined topics within the response;
(d) providing at least one closed-ended question with respect to any member of the set of user-defined topics not identified in step number (c).

15. The system of claim 13, wherein the processor is further configured to generate at least one closed-ended question with respect to members of the user-defined topics identified in the consumer's response to the open-ended question.

16. The system of claim 14, wherein the closed-ended question includes a request to rate consumer satisfaction with respect to the goods or services.

17. The system of claim 16, wherein the processor is further configured to analyze the text of said response to the open-ended question to identify sentiment measure regarding said goods or services; and wherein the processor is further configured to assign an ordinal data value to consumer sentiment based on the textual analysis of the consumer's response to said open-ended question.

18. The system of claim 16, further comprising assessing a confidence interval of the identified consumer sentiment regarding the goods or services and generating at least one closed-ended question to specifically identify consumer sentiment if the confidence interval is below a user-defined threshold.

19. The system of claim 14, wherein the processor is further configured to terminate the survey if the number of questions exceeds a user-defined threshold value.

20. A method for conducting real-time dynamic consumer surveys, the method under control of one or more computer systems configured with executable instructions, comprising:
providing a set of user-defined topics of interest related to a good or service;
providing a processor configured for:
(a) beginning a consumer survey by asking the consumer to provide an overall rating of experience with the good or service and providing an open-ended question to the consumer of the specific good or service regarding the consumers experience with said good or service;
(b) receiving the consumer's response to said open-ended question;
(c) analyzing the text of said response to the open-ended question to identify the presence of members of the set of user-defined topics within the response;
(d) providing at least one closed-ended question with respect to any member of the set of user-defined topics not identified in step number (c), wherein said closed-ended question is a function of a predetermined set of rules.
